(19) United States
(12) Patent Application Publication
(10) Pub. No.: US 2016/0222817 A1
(43) Pub. Date: Aug. 4, 2016

(54) PRESSURE REGULATING SYSTEMS

(71) Applicant: United Technologies Corporation, Hartford, CT (US)

(72) Inventor: Michael Ronan, East Hartford, CT (US)

(21) Appl. No.: 14/917,910

(22) PCT Filed: Jul. 30, 2014
(86) PCT No.: PCT/US2014/048840

§ 371 Date: Mar. 9, 2016

Related U.S. Application Data
(60) Provisional application No. 61/875,839, filed on Sep. 10, 2013.

(51) Int. Cl. F01D 17/24; B64D 15/02; F04D 29/32; B64D 13/02; F01D 5/02; F01D 15/10

(52) U.S. Cl. CPC F01D 17/24; F01D 5/02; F01D 15/10; F04D 29/321; B64D 13/02; B64D 15/02; F05D 2220/32; F05D 2220/76; F05D 2260/43; F05D 2270/3013

(57) ABSTRACT

A fluid pressure regulating system includes a turbomachine configured and adapted to pressurize fluid in a first mode and to depressurize fluid in a second mode. An energy exchange device is operatively connected to the turbomachine to provide power to drive the turbomachine in the first mode to pressurize fluid, and to be driven by the turbomachine in the second mode to receive power from depressurization of fluid. The turbomachine and energy exchange device are configured and adapted to selectively switch between the first and second modes to output fluid at a substantially constant pressure using fluid supplied at pressures that vary ranging from above and below the substantially constant pressure.

### RELATED APPLICATIONS

This application claims the benefit of and priority to U.S. Provisional Patent Application No. 61/875,839 filed Sep. 10, 2013, the contents of which are incorporated herein by reference in their entirety.

### BACKGROUND OF THE INVENTION

1. Field of the Invention

The present disclosure relates to turbomachines, and more particularly to turbomachines for supplying pressurized gas at a substantially constant pressure.

2. Description of Related Art

A variety of devices require a substantially constant supply of pressurized fluid in order to function properly. For example, secondary aircraft systems such as environmental control or wing anti-ice bleed systems often require an input supply of constant pressure gas. A source of pressurized gas, for example, is present in the compressor of gas turbine engine aircraft. However, in normal operation of an aircraft the engine speed changes and the pressures available from the compressor can vary considerably.

There have been some traditional solutions for supplying substantially constant output pressure given a variable pressure source. For example, some traditional systems require a pressure supply that never falls below a minimum supply pressure. As long as the minimum supply pressure is above the required constant output pressure, the output pressure can be maintained. A pressure regulating valve is used to reduce pressure from the supply as needed to output the constant pressure to the secondary system. This type of system utilizes excessive energy under most circumstances to ensure there is always sufficient pressure available.

Alternative solutions also exist. Some traditional systems utilize multiple different pressure supplies, dedicated compressors to ensure fluid from a potentially low pressure source is raised to meet the pressure requirement, or passing fluid through a turbine to recover energy from a high pressure source. These solutions each potentially have individual drawbacks including increased complexity of the fluid delivery system, use of a less efficient compressor than that originally compressing the fluid, and efficiency loss associated with passing high pressure fluid through a turbine.

Such conventional methods and systems have generally been considered satisfactory for their intended purpose. However, there is still a need in the art for systems and methods that allow for improved delivery of pressurized fluids. There also remains a need in the art for such systems and methods that are easy to make and use. The present disclosure provides a solution for these problems.

### SUMMARY OF THE INVENTION

A fluid pressure regulating system includes a turbomachine configured and adapted to pressurize fluid in a first mode and to depressurize fluid in a second mode. An energy exchange device is operatively connected to the turbomachine to provide power to drive the turbomachine in the first mode to pressurize fluid, and to be driven by the turbomachine in the second mode to receive power from depressurization of fluid. The turbomachine and energy exchange device are configured and adapted to selectively switch between the first and second modes to output fluid at a substantially constant pressure using fluid supplied at pressures that vary ranging from above and below the substantially constant pressure.

In certain embodiments, a mechanical linkage operatively connects the turbomachine and the energy exchange device to drive the turbomachine in the first mode and to drive the energy exchange device in the second mode. A controller can be operatively connected to the energy exchange device to maintain a substantially constant output pressure in the first and second modes by controlling the power for driving the turbomachine in the first mode and by regulating the amount of power drawn from the turbomachine in the second mode given a supply pressure that varies ranging above and below the substantially constant output pressure. In certain embodiments, the energy exchange device includes an electrical machine configured to convert electrical power supplied to the electrical machine in the first mode to drive the turbomachine, and to convert mechanical power from the turbomachine in the second mode into electrical power.

An energy system can be operatively connected to the energy exchange device to supply power to the energy exchange device in the first mode and to receive power from the energy exchange device in the second mode. The energy system can include a battery, a vehicle electrical system, an electrical power bus of a building connected to a power grid, or the like. In an exemplary embodiment, the energy system includes a flywheel and the energy exchange device includes a transmission operatively connected to be driven by the flywheel in the first mode and to drive the flywheel in the second mode.

It is contemplated that the turbomachine can include a turbine-compressor component configured to pressurize gas in the first mode and to take power off of pressurized gas in the second mode. It is also contemplated that the turbomachine can include a hydraulic turbine-pump component configured to pressurize liquid in the first mode and to take power off pressurized liquid in the second mode. Any other suitable type of turbomachine can be used without departing from the scope of this disclosure.

A gas pressure regulating system as described above can be used for supplying pressurized gas to secondary aircraft systems. It is also contemplated that a gas turbine engine can include a system as described above and a main compressor operatively connected to be driven by a main turbine to compress air. The turbomachine can have an inlet in fluid communication with the main compressor for supplying variable pressure bleed air for pressure regulation by the turbomachine.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a fluid regulating system constructed in accordance with the present disclosure, showing the turbomachine and energy exchange device; and

FIG. 2 is a schematic view of the system of FIG. 1, showing the system connected to a gas turbine engine.

### DETAILED DESCRIPTION OF THE PREFERRED EMBODIMENTS

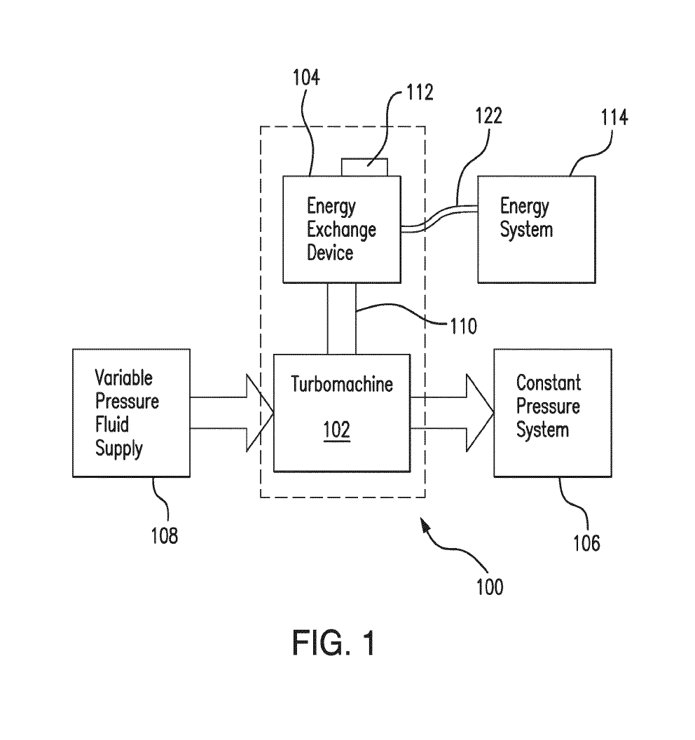

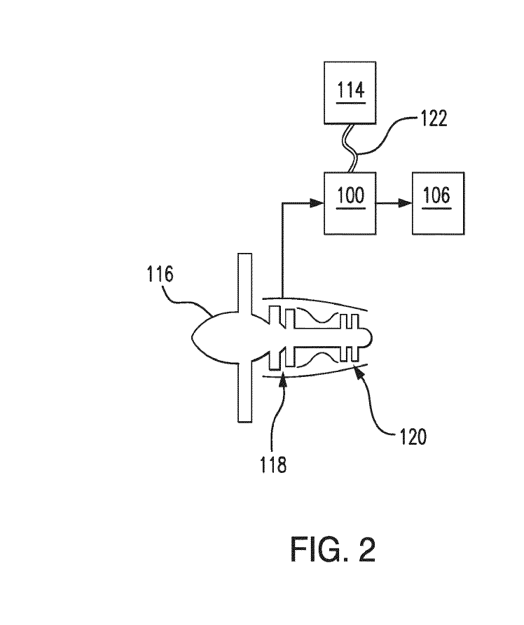

Reference will now be made to the drawings wherein like reference numerals identify similar structural features or aspects of the subject disclosure. For purposes of explanation and illustration, and not limitation, a partial view of an exemplary embodiment of a fluid pressure regulating system in accordance with the disclosure is shown in FIG. 1 and is designated generally by reference character 100. Other embodiments of pressure regulating systems in accordance with the disclosure, or aspects thereof, are provided in FIG. 2, as will be described. The systems and methods described herein can be used to supply a constant fluid pressure from a variable pressure source.

Pressure regulating system 100 includes a turbomachine 102 configured and adapted to pressurize fluid in a first mode and to depressurize fluid in a second mode. An energy exchange device 104 is operatively connected to turbomachine 102 to provide power to drive turbomachine 102 in the first mode to pressurize fluid, and to be driven by turbomachine 102 in the second mode to receive power from depressurization of fluid. Turbomachine 102 and energy exchange device 104 are configured and adapted to selectively switch between the first and second modes to output fluid at a substantially constant pressure to a constant pressure type system 106, such as an aircraft environmental control system (ESC), wing anti-icing (WAI) bleed system, or any other system needing a substantially constant input pressure. Pressure regulating system 100 can provide the constant output pressure using fluid supplied from a source, variable pressure supply 108 that provides input pressures to turbomachine 102 that vary ranging from above and below the substantially constant pressure. In other words, regardless of whether the supply pressure is above or below the required constant pressure, pressure regulating system 100 can maintain the constant output pressure.

A mechanical linkage 110 operatively connects turbomachine 102 and energy exchange device 104 to drive turbomachine 102 in the first mode and to drive energy exchange device 104 in the second mode. A controller 112 is connected to energy exchange device 112 to maintain a substantially constant output pressure in the first and second modes by controlling the power for driving turbomachine 112 in the first mode and by regulating the amount of power drawn from turbomachine 112 in the second mode. This can be accomplished using feedback, for example from one or more sensors connected to monitor pressures in variable pressure supply 108 and/or the outlet of turbomachine 102. Controller 112 can control the rotor speed in turbomachine 102 given a supply pressure that varies, and can switch operation between the first and second modes when the supply pressure passes above and below the substantially constant output pressure. For example, energy exchange device 104 can include an electrical machine that operates as motor to convert electrical power supplied to the electrical machine in the first mode into mechanical power to drive the turbomachine 102. In the second mode, the electrical machine can operate as a generator to convert mechanical power from the turbomachine 102 in the second mode into electrical power. Controller 112 can control the speed and mode, e.g., generator or motor, of the electrical machine. Controller 112 can be optionally omitted in self-controlling embodiments. For example in a flywheel embodiment as described below, a mechanical transmission system can be used for energy exchange with active control or without active control. A passive pneumatic or hydraulic control could be used in conjunction with a continuously variable drive ratio transmission, for example to passively control a flywheel embodiment. For example, a pneumatic control would cause the transmission to increase the speed of the turbomachine relative to the flywheel if pressure is below the target, and reduce speed if pressure is above the target.

An energy system 114 can be operatively connected to pressure regulating system 100. For example, energy system 114 can be directly connected to energy exchange device 104 to supply power to energy exchange device 104 in the first mode and to receive power from energy exchange device 104 in the second mode. For example, in embodiments where energy exchange device 104 includes an electrical machine as described above, energy system 114 can include a battery for storing electrical energy received from the electrical machine operating as a generator, and to provide energy to the electrical machine operating as a motor. Any other suitable type of electrical energy system can be used. For example, the electrical energy system can include a vehicle electrical system such as a power bus in an aircraft or surface vehicle. If pressure regulating system 100 is used to provide constant pressure shop air, for example, energy system 114 can include an electrical power bus of a building connected to a power grid, or the like. As another example, energy system 114 can include a flywheel and energy exchange device 104 can include a transmission operatively connected to be driven by the flywheel in the first mode and to drive the flywheel in the second mode. Energy system 114 and energy exchange device 104 are connected together by an energy link 122, which can be an electrical cable in systems using electrical energy, or a mechanical linkage in systems using a flywheel, for example.

Turbomachine 102 can include a turbine-compressor component configured to pressurize gas in the first mode and to take power off of pressurized gas in the second mode, so a gas pressure regulating system as described herein can be used for supplying pressurized gas to secondary aircraft systems. The turbine-compressor component can be an axial type turbomachine, a centrifugal machine, or any other suitable type of device. However use with pressurized gas is exemplary only, as it is also contemplated that turbomachine 102 can include a hydraulic turbine-pump component configured to pressurize liquid in the first mode and to take power off pressurized liquid in the second mode. In the event of the source pressure being very close or exactly on the required constant output pressure, turbomachine 102 can freewheel, neither requiring power to be driven, nor producing any power.

Referring now to FIG. 2, an exemplary application of a fluid pressure regulating system such as pressure regulating system 100 is shown. Gas turbine engine 116 can include a pressure regulating system 100 as described above. A main compressor 118 is operatively connected to be driven by a main turbine 120 to compress air. The turbomachine, e.g., turbomachine 102 in FIG. 1, can have an inlet in fluid communication with main compressor 118 for supplying variable pressure bleed air for pressure regulation by the turbomachine. So in this example, main compressor 118 takes the place of the variable pressure fluid supply, e.g., variable pressure supply 108 of FIG. 1. Constant pressure gas can be supplied from the turbomachine to secondary aircraft systems, e.g., constant pressure system 106. The main power bus of the aircraft can serve as the energy system 114, supplying or storing energy to and from an electrical machine, e.g., energy exchange device 104 of FIG. 1.

Using the systems and methods described herein in place of traditional systems and methods can make use of the highly efficient primary compressor, operating at a pressure level that may vary depending on primary system demands, while alternatively recovering what would otherwise be waste energy or adding the minimum additional energy to the working fluid when the source differs from the required constant output pressure for a secondary system, in gas turbine engine applications for example. This can also allow avoidance of the additional complexity of multiple fluid sources used in some traditional systems. Additionally, in systems where high fluid temperatures are undesirable, the optimization in system efficiency with respect to pressure can reduce or minimize the delivery temperature. Those skilled in the art will readily appreciate the components such as exemplary energy systems, energy exchange devices, and turbomachines described herein are non-limiting, and that the systems disclosed herein can be adapted for any other suitable application without departing from the scope of this disclosure.

The methods and systems of the present disclosure, as described above and shown in the drawings, provide for constant pressure fluid output with superior properties including the ability to utilize a fluid source having a pressure that can vary both above and below the constant output pressure. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A fluid pressure regulating system comprising:
a turbomachine; and
an energy exchange device operatively connected to the turbomachine to provide power to drive the turbomachine in the first mode, and to be driven by the turbomachine in the second mode, wherein the turbomachine and energy exchange device are configured to selectively switch between the first and second modes to output fluid at a substantially constant pressure using fluid supplied at pressures that vary ranging from above and below the substantially constant pressure.

2. A system as recited in claim 1, further comprising a mechanical linkage operatively connecting the turbomachine and the energy exchange device to drive the turbomachine in the first mode and to drive the energy exchange device in the second mode.

3. A system as recited in claim 1, wherein the energy exchange device includes an electrical machine configured to convert electrical power supplied to the electrical machine in the first mode to drive the turbomachine, and to convert mechanical power from the turbomachine in the second mode into electrical power.

4. A system as recited in claim 1, further comprising an energy system operatively connected to the energy exchange device to supply power to the energy exchange device in the first mode and to receive power from the energy exchange device in the second mode.

5. A system as recited in claim 4, wherein the energy system includes a battery.

6. A system as recited in claim 4, wherein the energy system includes an electrical power bus of a building connected to a power grid.

7. A system as recited in claim 4, wherein the energy system includes a vehicle electrical system.

8. A system as recited in claim 4, wherein the energy system includes a flywheel, and wherein the energy exchange device includes a transmission operatively connected to be driven by the flywheel in the first mode and to drive the flywheel in the second mode.

9. A system as recited in claim 1, wherein the turbomachine includes a turbine-compressor component configured to pressurize gas in the first mode and to take power off of pressurized gas in the second mode.

10. A system as recited in claim 1, wherein the turbomachine includes a hydraulic turbine-pump component configured to pressurize liquid in the first mode and to take power off pressurized liquid in the second mode.

11. A system as recited in claim 1, further comprising a controller operatively connected to the energy exchange device to maintain a substantially constant output pressure in the first and second modes by controlling the power for driving the turbomachine in the first mode and by regulating the amount of power drawn from the turbomachine in the second mode given a supply pressure that varies ranging above and below the substantially constant output pressure.

12. A gas pressure regulating system for supplying pressurized gas to secondary aircraft systems comprising:
a turbomachine; and
an electrical machine operatively connected to the turbomachine to convert electrical power supplied to the electrical machine in the first mode to drive the turbomachine, and to convert mechanical power from the turbomachine in the second mode into electrical power.

13. A system as recited in claim 12, further comprising a controller operatively connected to the electrical machine to maintain a substantially constant gas output pressure from the turbomachine in the first and second modes by controlling the power for driving the turbomachine in the first mode and by regulating the amount of power drawn from the turbomachine in the second mode given a supply pressure that varies ranging above and below the substantially constant output pressure.

14. A gas turbine engine comprising:
a main compressor operatively connected to be driven by a main turbine to compress air;
a turbomachine; and
an electrical machine operatively connected to the turbomachine to convert electrical power supplied to the electrical machine in the first mode to drive the turbomachine, and to convert mechanical power from the turbomachine in the second mode into electrical power, wherein the turbomachine has an inlet in fluid communication with the main compressor for supplying variable pressure bleed air for pressure regulation by the turbomachine.

15. A gas turbine engine as recited in claim 14, further comprising a controller operatively connected to the electrical machine to maintain a substantially constant gas output pressure from the turbomachine in the first and second modes by controlling the power for driving the turbomachine in the first mode and by regulating the amount of power drawn from the turbomachine in the second mode given a supply pressure that varies ranging above and below the substantially constant output pressure.
